(19) United States
(12) Patent Application Publication
(10) Pub. No.: US 2016/0300530 A1
(43) Pub. Date: Oct. 13, 2016

(54) ORGANIC LIGHT EMITTING DIODE DISPLAY PANEL, DRIVING METHOD THEREOF, AND DISPLAY DEVICE

(71) Applicant: BOE TECHNOLOGY GROUP CO., LTD., Beijing (CN)

(72) Inventor: Ying WANG, Beijing (CN)

(73) Assignee: BOE TECHNOLOGY GROUP CO., LTD., Beijing (CN)

(21) Appl. No.: 14/437,007

(22) PCT Filed: Nov. 5, 2014
(86) PCT No.: PCT/CN2014/090360

§ 371 Date: Apr. 20, 2015

(30) Foreign Application Priority Data
May 15, 2014 (CN) 201410204263.4

(51) Int. Cl. G09G 3/3258; G09G 3/20

(52) U.S. Cl. CPC G09G 3/3258; G09G 3/2074; G09G 2330/02; G09G 2320/029; G09G 2320/0233

(57) ABSTRACT

The present invention provides an organic light emitting diode display panel, a driving method thereof, and an organic light emitting diode display device, to solve the problem that the voltage compensation circuit of the existing organic light emitting diode display panel is complicated in structure. The organic light emitting diode display panel comprises: an array substrate provided with a plurality of sub-pixels; a power supply supplying power to the sub-pixels in the array substrate; a first lead connecting the array substrate with the power supply; a current detection unit configured to detect a current in the first lead; and a control unit configured to control an output voltage of the power supply according to a detection result of the current detection unit.

### FIELD OF THE INVENTION

The present invention relates to the field of organic light emitting diode (OLED) display technology, and particularly relates to an organic light emitting diode display panel, a driving method thereof, and an organic light emitting diode display device.

### BACKGROUND OF THE INVENTION

In an organic light emitting diode display panel, an organic light emitting diode for emitting light is provided in each sub-pixel, and the brightness of the organic light emitting diode is determined by a current flowing therethrough and a voltage loaded thereto. The current flowing through the organic light emitting diode is determined by a signal on a data line corresponding to the organic light emitting diode, and thus the brightness of the sub-pixel may be controlled by the data line. With other conditions unchanged, the voltage loaded to the organic light emitting diode is determined by a supply voltage (V_{dd}), and the supply voltage of each sub-pixel are provided in a unified manner by a power supply located outside an array substrate.

The power supply is connected to the array substrate by a first lead (e.g., a lead located on a flexible printed circuit board), and then connected to the sub-pixels by a second lead in the array substrate, and these leads must have certain resistance. Therefore, when a current flows through the lead, a corresponding voltage drop (IR drop) is inevitably generated thereon, and when different pictures are displayed, the currents flowing through the organic light emitting diodes are different, so the IR drops of the leads are also different. Especially for the first lead, the current thereof is equal to the sum of the currents flowing through all the organic light emitting diodes, so the range of change of IR drop thereon is large, which may be zero to the minimum and may be hundreds of millivolts (e.g., 0.5V) to the maximum. With the output voltage of the power supply unchanged, the change of IR drop may result in the fact that the supply voltages actually loaded to the sub-pixels are also changed continuously, i.e., resulting in continuous change of the voltages loaded to the organic light emitting diodes, which in turn affects brightness of the organic light emitting diodes and reduces display quality.

In order to reduce the influence of the IR drop on display effect, a solution in the prior art is additionally providing a compensation circuit in each sub-pixel, for compensating the change of the supply voltage caused by the IR drop. However, adding a compensation circuit to each sub-pixel inevitably results in a more complicated circuit structure of the array substrate, increases the difficulty in design and preparation, increases production cost, and especially for a high-resolution organic light emitting diode display panel, each sub-pixel of which is very small in size, and there is no extra space for adding the compensation circuit.

### SUMMARY OF THE INVENTION

In view of the problem that the voltage compensation structure of the existing organic light emitting diode display panel is complicated, the embodiments of the present invention provide an organic light emitting diode display panel with a simple structure, a driving method thereof, and an organic light emitting diode display device.

An embodiment of the present invention provides an organic light emitting diode display panel, comprising: an array substrate provided with a plurality of sub-pixels; a power supply supplying power to the plurality of sub-pixels; a first lead connecting the array substrate with the power supply; a current detection unit configured to detect a current in the first lead; and a control unit configured to control an output voltage of the power supply according to the current detected by the current detection unit.

The current detection unit may include a Hall current sensor.

The organic light emitting diode display panel may further comprise a flexible printed circuit board. At least part of the first lead is arranged on the flexible printed circuit board, and the current detection unit is arranged on the flexible printed circuit board.

The organic light emitting diode display panel may further comprise a comparison unit configured to compare the current detected by the current detection unit with a preset threshold current. The control unit controls the output voltage of the power supply to be a rated value when the detected current is smaller than or equal to the threshold current, and adjusts the output voltage of the power supply according to the detected current when the detected current is larger than the threshold current.

When the detected current is larger than the threshold current, the control unit retrieves a voltage value corresponding to the detected current in a preset correspondence table, and controls the output voltage of the power supply to be equal to the voltage value.

An embodiment of the present invention provides a driving method of an organic light emitting diode display panel, the organic light emitting diode display panel comprising an array substrate provided with a plurality of sub-pixels, a power supply supplying power to the plurality of sub-pixels and a first lead connecting the array substrate with the power supply, the driving method comprising steps of: detecting a current in the first lead; and controlling an output voltage of the power supply according to the detected current in the first lead.

The driving method may further comprise a step of comparing the detected current in the first lead with a preset threshold current. The output voltage of the power supply is controlled to be a rated value if the detected current is smaller than or equal to the threshold current, and the output voltage of the power supply is adjusted according to the detected current if the detected current is larger than the threshold current.

In the driving method, when the detected current is larger than the threshold current, a voltage value corresponding to the detected current is retrieved in a preset correspondence table, and the output voltage of the power supply is controlled to be equal to the voltage value.

The maximum value of the voltage value satisfies Vₘₐₓ=V_{dd}′+(IR)_{zmax}, wherein V_{dd}′ is a rated supply voltage, and (IR)_{zmax} is a total IR drop at a midpoint position of the array substrate when the brightness of the organic light emitting diode display panel reaches the maximum.

An embodiment of the present invention provides an organic light emitting diode display device comprising the above-mentioned organic light emitting diode display panel.

In the organic light emitting diode display panel of the embodiment of the present invention, the current in the first lead may be detected, and the current in the first lead may reflect an overall IR drop of the organic light emitting diode display panel, so the overall IR drop may be compensated merely by adjusting the output voltage of the power supply according to the current, so that the voltage actually loaded to each sub-pixels is close to the rated supply voltage thereof as much as possible, thus improving display effect. In addition, in the organic light emitting diode display panel, it is sufficed to only provide one current detection unit and one control unit, instead of additionally providing an extra compensation circuit in each sub-pixel, so the organic light emitting diode display panel is simple in structure, easy to manufacture and has low cost.

### BRIEF DESCRIPTION OF THE DRAWINGS

FIG. 1 is a schematic diagram of a configuration structure of an organic light emitting diode display panel of a first embodiment of the present invention.

FIG. 2 is a structural schematic diagram of a current detection unit and a comparison unit in an array substrate of the organic light emitting diode display panel of the first embodiment of the present invention.

FIG. 3 is a flow diagram of a driving method of the organic light emitting diode display panel of the first embodiment of the present invention.

FIG. 4 is an equivalent circuit diagram of the array substrate of the organic light emitting diode display panel of the first embodiment of the present invention.

FIG. 5 is a schematic diagram illustrating an IR drop distribution in the array substrate of the organic light emitting diode display panel of the first embodiment of the present invention.

### DETAILED DESCRIPTION OF THE EMBODIMENTS

To make the person skilled in the art better understand the technical solution of the present invention, the present invention is further described below in details in conjunction with the accompanying drawings and the specific embodiments.

### First Embodiment

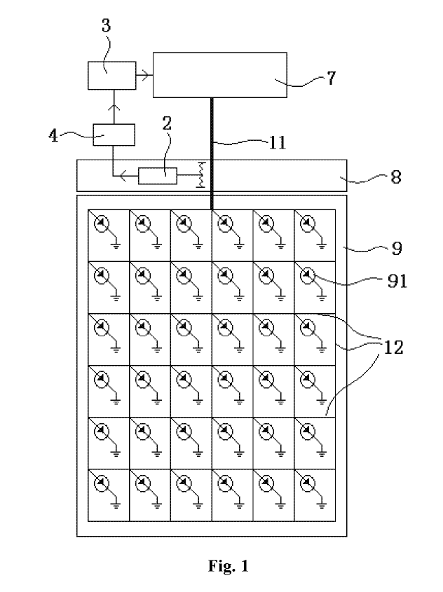

As shown in FIGS. 1 to 5, the embodiment provides an organic light emitting diode display panel and a driving method thereof.

As shown in FIG. 1, the organic light emitting diode display panel includes an array substrate 9, which is provided with a plurality of sub-pixels 91 for display. Each sub-pixel 91 includes such a structure as a drive thin film transistor, a switch thin film transistor, a storage capacitor, an organic light emitting diode or the like, and only an organic light emitting diode is shown in FIG. 1 to represent the sub-pixel 91. In addition, the array substrate 9 is further provided with other structures such as gate lines, data lines and the like, but these structures are known structures, and thus are not marked in FIG. 1.

A power supply 7 is provided external to the array substrate 9, and is connected to the array substrate 9 by a first lead 11, and then connected to the sub-pixels 91 by a grid-like second lead 12, so as to provide supply voltages needed for display to the sub-pixels 91.

Each of the first lead 11 and the second lead 12 necessarily has a certain resistance, and therefore when a current flows therethrough, a certain IR drop will occur thereon, thereby changing the supply voltage actually loaded to the sub-pixel 91.

The organic light emitting diode display panel of the embodiment further includes a current detection unit 2 and a control unit 3. The current detection unit 2 is configured to detect the current in the first lead 11, and the control unit 3 is configured to control an output voltage of the power supply 7 according to a detection result of the current detection unit 2.

The amplitude of the IR drop of each lead is determined by current and resistance, and the resistance of the lead of a specific display panel is already fixed, so the current value may directly reflect the IR drop on the lead. As the current in the first lead 11 is the sum of currents in all the sub-pixels 91, the current value may represent the overall IR drop of the display panel. The control unit 3 may adjust the output voltage of the power supply 7 according to the current, to achieve compensation for the overall IR drop, so that the voltage actually loaded to each sub-pixel 91 is close to the rated supply voltage (i.e. the voltage when the sub-pixel 91 just works in a preset manner) as much as possible, so as to achieve a better display effect.

It should be understood that, the current in the first lead 11 cannot accurately reflect a specific IR drop on each sub-pixel 91 (the IR drop includes the IR drop on the first lead 11 and that on the second lead 12 connected to the sub-pixel 91), but as a displayed picture usually has some overall characteristics (for example, the picture is relatively dark or bright overall), compensating for the IR drop according to the current in the first lead 11 can improve the display effect. Moreover, as compared with the method in the prior art in which individual compensation is performed on each sub-pixel 91 (i.e. a compensation circuit is added to each sub-pixel 91), the organic light emitting diode display panel of the embodiment is much simpler, easy to manufacture, and has low cost.

The organic light emitting diode display panel of the embodiment further includes a flexible printed circuit board (FPC) 8, and the first lead 11 is at least partially located on the flexible printed circuit board 8. The current detection unit 2 is arranged on the flexible printed circuit board 8, and is configured to detect the current in the first lead 11 located on the flexible printed circuit board 8.

The flexible printed circuit board 8 is usually provided outside an edge of the array substrate 9, and configured to connect various circuits to the array substrate 9, and lead a drive signal into the array substrate 9, and the power supply also needs to be led to the array substrate 9 by the first lead 11 on the flexible printed circuit board 8. Therefore, if the current detection unit 2 is integrated on the flexible printed circuit board 8 to detect the current in the first lead 11 located on the flexible printed circuit board 8, it is not required to change the structure of the array substrate 9, nor to separately add a new detection device, and thus the structure of the organic light emitting diode display panel may be simpler.

The current detection unit 2 may include a Hall current sensor H.

The Hall current sensor H is a current sensing device based on magnetic balance principle of Hall effect (closed-loop principle), which can generate a voltage signal (Hall potential) according to the current with a specific formula Vₕ=I_{C}×B×K_{H}×sin θ, wherein Vₕ is a Hall potential, I_{C} is a current, B is a magnetic flux density, K_{H} is a Hall coefficient, and θ is an included angle between the current and a direction of a magnetic field. The Hall current sensor H has the advantages of simple structure, high precision and the like.

The organic light emitting diode display panel may further include a comparison unit 4 configured to compare the detection result of the current detection unit 2 with a preset threshold current. The control unit 3 is configured to control the output voltage of the power supply 7 to be a rated value when the detection result is smaller than or equal to the threshold current, and adjust the output voltage of the power supply 7 according to the detection result when the detection result is larger than the threshold current.

When the current in the first lead 11 is small, the resulting IR drop is also relatively small, without obvious influence on the display effect. Therefore, the threshold current may be set in advance according to the performance of the display panel, and when the current in the first lead 11 is smaller than the threshold current, the influence of the IR drop may be considered to be very small, there is no need to adjust the output voltage of the power supply 7, and thus the computation amount of the control unit 3 and the times of adjusting the power supply 7 may be reduced, so that display is more stable.

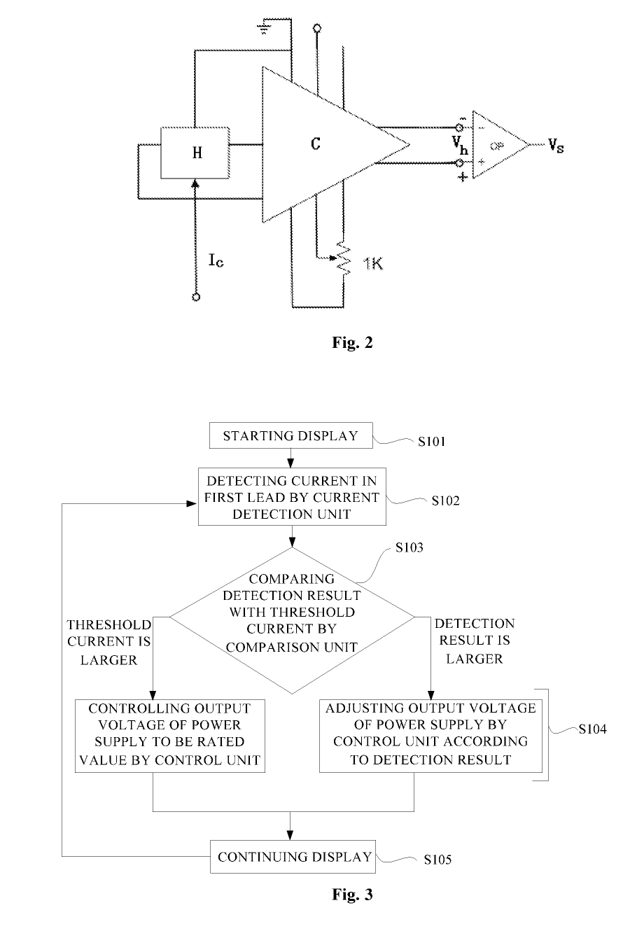

The comparison unit 4 may be a known comparator C or a chip. For example, as shown in FIG. 2, the Hall current sensor H detects the current I_{C} and generates an induced potential Vₕ, which enters the comparator C for comparison, and then enters an amplifier OP for amplification, and the amplified signal becomes a voltage signal V_{S} for identification by the control unit 3. It should be understood that the current detection unit 2, the comparison unit 4 and the like may take various specific forms, which will not be described in detail herein.

As shown in FIG. 3, the driving method of the organic light emitting diode display panel includes the following steps S101 through S105.

In step S101, display is started. That is to say, the organic light emitting diode display panel starts displaying the desired content such that each sub-pixel 91 generates a specific gray scale value and generate a corresponding current for each frame of picture.

In step S102, the current detection unit 2 detects the current in the first lead 11.

When a certain picture is displayed, as the sub-pixels 91 start emitting light, currents flow therethrough, the sum of the currents is the current in the first lead 11, which can be detected by the current detection unit 2.

In step S103, the comparison unit 4 compares the detection result of the current detection unit 2 with the preset threshold current. That is to say, the comparison unit 4 is used to compare the actual current with the preset threshold current, to determine how to control the output voltage of the power supply in the subsequent steps.

In step S104, the control unit 3 controls the output voltage of the power supply 7 according to the detection result of the current detection unit 2. That is to say, the output voltage of the power supply 7 is controlled according to the detection result of the current detection unit 2, so that the voltage actually loaded to each sub-pixels 91 after subjected to the IR drop loss across the first lead and the second lead is close to the rated supply voltage as much as possible.

Specifically, the step may include: controlling the output voltage of the power supply 7 to be a rated value if the detection result is smaller than or equal to the threshold current, and adjusting the output voltage of the power supply 7 according to the detection result if the detection result is larger than the threshold current.

As described above, when the current in the first lead 11 is small, the corresponding IR drop is also small, without great influence on the display effect, so it is feasible for the power supply 7 to output in a conventional way, without changing the output voltage thereof. Whereas when the current in the first lead 11 is large, the IR drop varies with the magnitude of the current, and the output voltage of the power supply 7 needs to be adjusted according to the current value, to compensate for the IR drop, so that the voltage actually loaded to each sub-pixel 91 is close to the rated supply voltage thereof as much as possible.

For example, a correspondence table may be created, to store the correspondence relationship between the current and the output voltage, and the step may include: retrieving a voltage value corresponding to the detection result of the current detection unit 2 in the preset correspondence table, and controlling the output voltage of the power supply 7 to be equal to the voltage value, by the control unit 3.

That is to say, it is possible to calculate respective overall IR drops of the display panel at different currents in advance, and calculate output voltages corresponding to the different currents (the output voltage is equal to the rated supply voltage plus the corresponding IR drop) according to the calculation result, and input the correspondence relationship therebetween to a table. During display, when a certain current value is detected, it is only required to search for the voltage value corresponding thereto in the table. Such a driving method using the correspondence table is simple, practical and quick, and needs little computation.

The maximum value of the above voltage value (i.e. the maximum value of the output voltage of the power supply 7) is Vₘₐₓ=V_{dd}′+(IR)_{zmax}, wherein V_{dd}′ is a rated supply voltage, and (IR)_{zmax} is a total IR drop at a midpoint position of the array substrate 9 when the brightness of the organic light emitting diode display panel reaches the maximum.

Specifically, the IR drop in the organic light emitting diode display panel includes two parts. One part is the IR drop on the first lead 11, which is in direct proportion to the current in the first lead 11, and the IR drop reaches the maximum value when the display panel displays a white picture with the maximum brightness (i.e. the brightness of each sub-pixel 91 reaches the maximum).

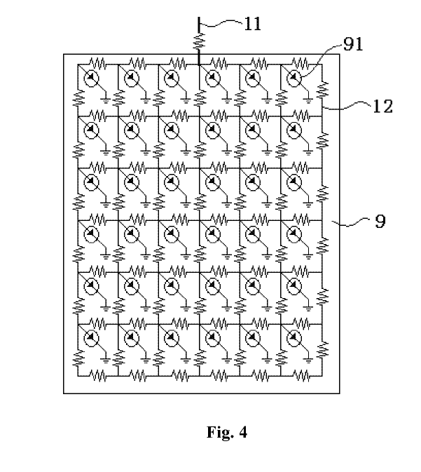

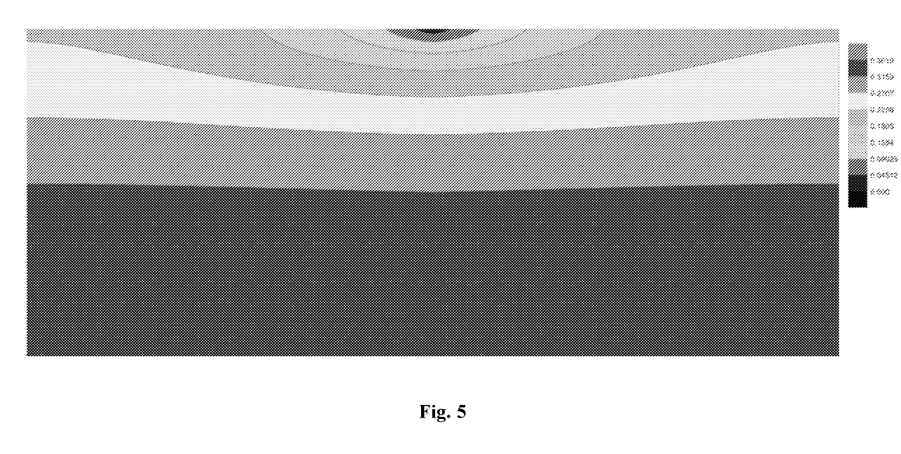

The other part of the IR drop in the organic light emitting diode display panel is an IR drop caused by the second lead 12 on the array substrate 9, and an equivalent circuit diagram of this part of circuit is shown in FIG. 4. It can be seen that as the second lead 12 has a grid shape in this case, and currents flowing through different parts thereof are different, the IR drop distribution therein is often complicated. Research shows that the IR drop value generated at the midpoint position of the array substrate 9 is usually the maximum when the brightness of the displayed picture is relatively uniform. For example, in the case of a display panel of WVGA mode (RGB, 480×800), when it displays a white picture with the maximum brightness, the distribution of the IR drop (exclusive of the IR drop on the first lead 11) caused by the second lead 12 on the array substrate 9 is as shown in FIG. 5. Therefore, the IR drop (IR)_{zmax} (including the IR drop on the first lead 11 and that on the second lead 12) at the midpoint position of the array substrate 9 when a brightest white picture is displayed may be adopted as a possible maximum value of the IR drop, so that the maximum value of the output voltage that the power supply 7 may need is equal to V_{dd}′+(IR)_{zmax}.

In step S105, display is continued, and steps S102 through S104 are repeated.

That is to say, during display, the output voltage of the power supply 7 is adjusted continuously according to the current in the first lead 11 at all times by using the above method, so that the voltage actually loaded to each sub-pixel 91 is close to the rated supply voltage as much as possible, so as to achieve a real-time compensation for the IR drop and a better display effect.

### Second Embodiment

The embodiment provides an organic light emitting diode display device including the above-mentioned organic light emitting diode display panel. The organic light emitting diode display device may be applied to any product or component with a display function, such as electronic paper, a mobile phone, a tablet computer, a television, a display, a notebook computer, a digital photo frame, a navigator, or the like.

It should be understood that the above embodiments are only exemplary embodiments for illustrating the principle of the present invention, and however, the present invention is not limited thereto. Various variations and improvements can be made by a person of ordinary skill in the art without departing from the spirit and essence of the present invention, and these variations and improvements should also be considered to be within the protection scope of the present invention.

1. An organic light emitting diode display panel, comprising:
an array substrate provided with a plurality of sub-pixels;
a power supply supplying power to the plurality of sub-pixels;
a first lead connecting the array substrate with the power supply;
a current detection unit configured to detect a current in the first lead; and
a control unit configured to control an output voltage of the power supply according to the current detected by the current detection unit.

2. The organic light emitting diode display panel according to claim 1, wherein
the current detection unit includes a Hall current sensor.

3. The organic light emitting diode display panel according to claim 1, further comprising a flexible printed circuit board, wherein
at least part of the first lead is arranged on the flexible printed circuit board; and
the current detection unit is arranged on the flexible printed circuit board.

4. The organic light emitting diode display panel according to claim 1, further comprising a comparison unit configured to compare the current detected by the current detection unit with a preset threshold current, wherein
the control unit controls the output voltage of the power supply to be a rated value when the detected current is smaller than or equal to the threshold current, and adjusts the output voltage of the power supply according to the detected current when the detected current is larger than the threshold current.

5. The organic light emitting diode display panel according to claim 4, wherein
when the detected current is larger than the threshold current, the control unit retrieves a voltage value corresponding to the detected current in a preset correspondence table, and controls the output voltage of the power supply to be equal to the voltage value.

6. A driving method of an organic light emitting diode display panel, the organic light emitting diode display panel comprising an array substrate provided with a plurality of sub-pixels, a power supply supplying power to the plurality of sub-pixels and a first lead connecting the array substrate with the power supply, the driving method comprising steps of:
detecting a current in the first lead; and
controlling an output voltage of the power supply according to the detected current in the first lead.

7. The driving method of the organic light emitting diode display panel according to claim 6, further comprising a step of comparing the detected current in the first lead with a preset threshold current, wherein
the step of controlling an output voltage of the power supply according to the detected current in the first lead comprises: controlling the output voltage of the power supply to be a rated value if the detected current is smaller than or equal to the threshold current, and adjusting the output voltage of the power supply according to the detected current if the detected current is larger than the threshold current.

8. The driving method of the organic light emitting diode display panel according to claim 7, wherein
when the detected current is larger than the threshold current, a voltage value corresponding to the detected current is retrieved in a preset correspondence table, and the output voltage of the power supply is controlled to be equal to the voltage value.

9. The driving method of the organic light emitting diode display panel according to claim 8, wherein
the maximum value of the voltage value satisfies Vₘₐₓ=V_{dd}′+(IR)_{zmax}, wherein V_{dd}′ is a rated supply voltage, and (IR)_{zmax} is a total IR drop at a midpoint position of the array substrate when the brightness of the organic light emitting diode display panel reaches the maximum.

10. An organic light emitting diode display device, comprising an organic light emitting diode display panel, the organic light emitting diode display panel comprising:
an array substrate provided with a plurality of sub-pixels;
a power supply supplying power to the plurality of sub-pixels;
a first lead connecting the array substrate with the power supply;
a current detection unit configured to detect a current in the first lead; and
a control unit configured to control an output voltage of the power supply according to the current detected by the current detection unit.

11. The organic light emitting diode display device according to claim 10, wherein
the current detection unit includes a Hall current sensor.

12. The organic light emitting diode display device according to claim 10, further comprising a flexible printed circuit board, wherein
at least part of the first lead is arranged on the flexible printed circuit board; and
the current detection unit is arranged on the flexible printed circuit board.

13. The organic light emitting diode display device according to claim 10, further comprising a comparison unit configured to compare the current detected by the current detection unit with a preset threshold current, wherein
the control unit controls the output voltage of the power supply to be a rated value when the detected current is smaller than or equal to the threshold current, and adjusts the output voltage of the power supply according to the detected current when the detected current is larger than the threshold current.

14. The organic light emitting diode display device according to claim 13, wherein
when the detected current is larger than the threshold current, the control unit retrieves a voltage value corresponding to the detected current in a preset correspondence table, and controls the output voltage of the power supply to be equal to the voltage value.
